(19) United States
(12) Patent Application Publication
(10) Pub. No.: US 2011/0058382 A1
(43) Pub. Date: Mar. 10, 2011

(54) LIGHTING DEVICE FOR VEHICLE

(75) Inventors: Chiun-Jie LIN, Fontana, CA (US); Yung-Hua CHEN, Fontana, CA (US)

(73) Assignee: MAXZONE AUTO PARTS CORP., Fontana, CA (US)

(21) Appl. No.: 12/690,927

(22) Filed: Jan. 20, 2010

(30) Foreign Application Priority Data
Sep. 4, 2009 (TW) 98216420

(51) Int. Cl. F21V 7/00

(52) U.S. Cl. 362/518

(57) ABSTRACT

A lighting device for a vehicle is disclosed. The lighting device includes a light conducting rod, at least one light source, at least one first reflecting part, and at least one second reflecting part. The light source is connected to at least one end of the light conducting rod. The first reflecting part and the second reflecting part are located on the light conducting rod and respectively have a reflecting surface toward the light source. A first distance between the first reflecting part and the light source is less than a second distance between the second reflecting part and the light source, and the curvature of the reflecting surface of the second reflecting part is greater than the curvature of the reflecting surface of the first reflecting part.

### RELATED APPLICATIONS

This application claims priority to Taiwan Application Serial Number 98216420, filed Sep. 4, 2009, which is herein incorporated by reference.

### BACKGROUND

1. Technical Field

The present disclosure relates to illumination. More particularly, the present disclosure relates to reflector type modifiers.

2. Description of Related Art

For driving safety and pedestrians' safety, several different functions of optical devices for lighting, warning, or instruction need to be installed in a vehicle. The light emitted from the optical devices need to be consistent for providing well function of warning or lighting, no matter what function the optical device is.

However, the conventional lighting device for the vehicle has only one light source, and the light source is connected to the one end of the conventional lighting device. Most of the light emitted from the light source is refracted out of the conventional lighting device when the conventional lighting device is not straight line shaped. Alternatively, most of the light is totally reflected toward the other end of the conventional lighting device. Therefore, the intensity of the light refracted from the overall lighting device is different, so the brightness of the light refracted from overall lighting device is inconsistent.

### SUMMARY

According to one embodiment of the present invention, a lighting device for a vehicle is provided. The lighting device includes a light conducting rod, at least one light source, at least one first reflecting part, and at least one second reflecting part. The light source is connected to at least one end of the light conducting rod. The first reflecting part is located on the light conducting rod and has a reflecting surface toward the light source. The second reflecting part is located on the light conducting rod and has a reflecting surface toward the light source. A first distance between the first reflecting part and the light source is less than a second distance between the second reflecting part and the light source. The curvature of the reflecting surface of the second reflecting part is greater than the curvature of the reflecting surface of the first reflecting part.

According to another embodiment of the present invention, a lighting device for a vehicle is provided. The lighting device includes a light conducting rod, at least one light source, at least one first protrusion, at least one second protrusion, and at least one third protrusion. The light source is connected to at least one end of the light conducting rod. The first protrusion is located on the light conducting rod and has a linear side toward the light source. The second protrusion is located on the light conducting rod and has a curved side toward the light source. A first distance between the first protrusion and the light source is less than a second distance between the second protrusion and the light source. The third protrusion is located on the light conducting rod and has a curved side toward the light source. The second distance is less than a third distance between the third protrusion and the light source. The curvature of the curved side of the third protrusion is greater than the curvature of the curved side of the second protrusion.

### BRIEF DESCRIPTION OF THE DRAWINGS

FIG. 1A is a perspective view of a lighting device for a vehicle according to one embodiment of this invention;

FIG. 1B is an enlarged view of the part 1B of FIG. 1A;

FIG. 1C is a perspective view of the part 1C of FIG. 1A;

FIG. 2 is a plane view of a lighting device for a vehicle according to another embodiment of this invention;

FIG. 3 is a plane view of the curved side of the reflecting part of FIG. 2; and

FIGS. 4A-4E are plane views of lights hitting the reflecting parts sequentially.

### DETAILED DESCRIPTION

In the following detailed description for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

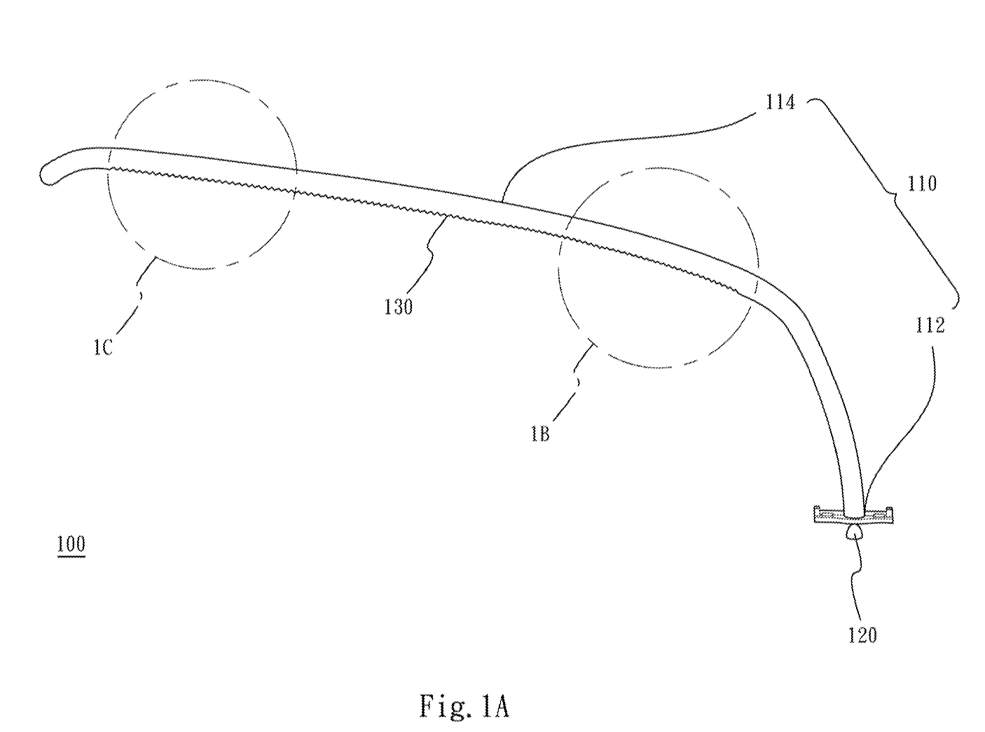

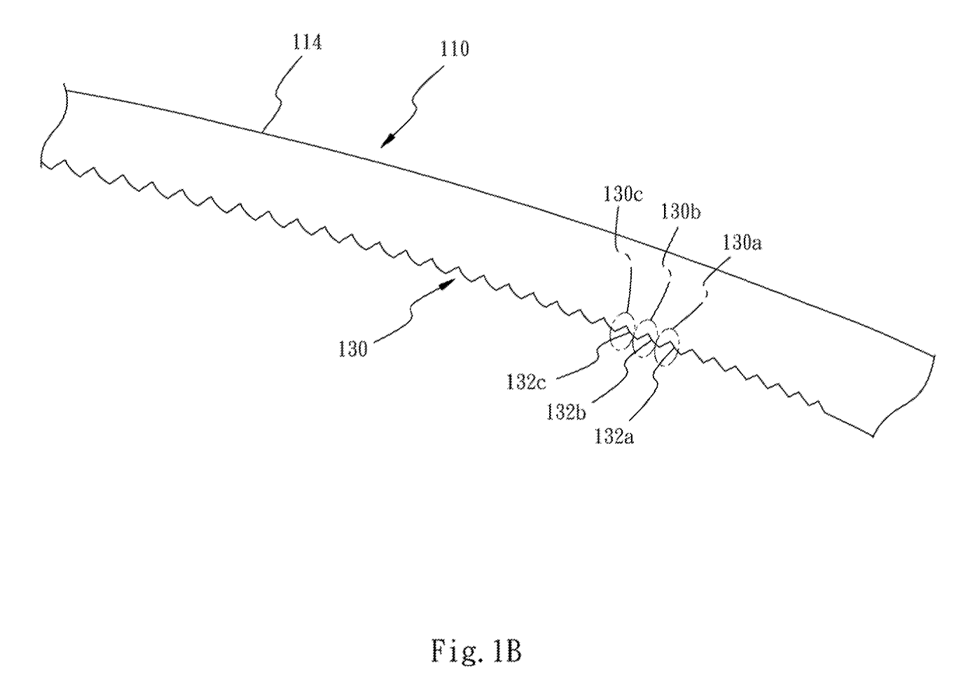

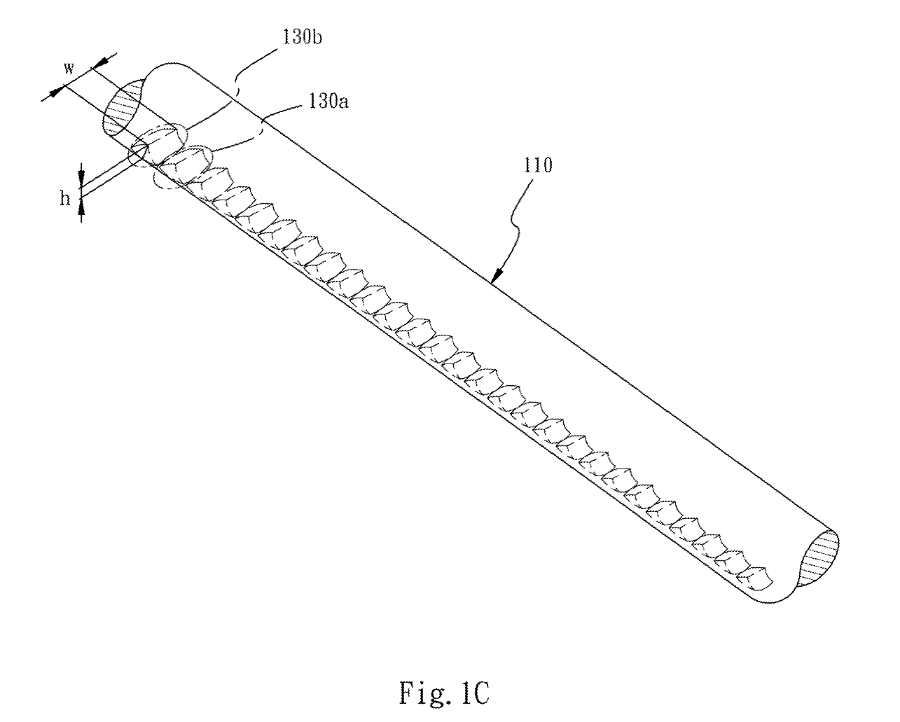

FIG. 1A is a perspective view of a lighting device 100 for a vehicle according to one embodiment of this invention. The lighting device 100 includes a light conducting rod 110, a light source 120, and several reflecting parts 130. The light conducting rod 110 has at least one light-receiving end 112 and a light-emitting surface 114. The light conducting rod 110 is solid and transparent. According to an embodiment, the light conducting rod 110 is made of polymethylmethacrylate. The light conducting rod 110 is bar-shaped (shown in FIG. 1A) or ring-shaped to provide different lighting shapes.

The light source 120 is connected to at least one end of the light conducting rod 110. In detail, the lights emitted from the light source 120 light toward the light-receiving end 112 of the light conducting rod 110.

FIG. 1B is an enlarged view of the part 1B of FIG. 1A. The reflecting parts 130 are protrusions located on the light conducting rod 110 and each has a reflecting surface 132 toward the light source 120. The curvatures of the reflecting surfaces 132 of the reflecting parts 130 gradually increase with the distance from the light source 120.

The first reflecting part 130a, the second reflecting part 130b and the third reflecting part 130c are taken as an example. The first reflecting part 130a, the second reflecting part 130b, and the third reflecting part 130c each has a reflecting surface 132a, 132b, 132c toward the light source 120. A first distance between the first reflecting part 130a and the light source 120 is less than a second distance between the second reflecting part 130b and the light source 120, and a third distance between the third reflecting part 130c and the light source 120 is greater than the second distance.

In addition, the curvature of the reflecting surface 132b of the second reflecting part 130b is greater than that of the reflecting surface 132a of the first reflecting part 130a, and the curvature of the reflecting surface 132c of the third reflecting part 130c is greater than that of the reflecting surface 132b of the second reflecting part 130b. Therefore, some lights are effectively reflected toward the other end of the lighting device 100 by the reflecting surfaces 132 of the reflecting parts 130 with different curvatures, and the other lights are refracted out of the lighting device 100. Since the intensity of the lights refracted from overall of the lighting device 100 are similar, the brightness of the lights refracted from overall lighting device are consistent.

FIG. 1C is an enlarged perspective view of the part 1C of FIG. 1A. The depths and/or the widths of the reflecting parts 130 are positively correlated with the distances between the reflecting parts 130 and the light source 120. In other words, the depth and/or the width of each reflecting part 130 can be increased as the increase of the distance between each reflecting part 130 and the light source 220.

In detail, since some lights are refracted out of the lighting device 100 after the lights are reflected by the first reflecting part 130a, the lights hitting the second reflecting part 130b are less. In order to increase the lights hitting the second reflecting part 130b, the depth h of the second reflecting part 130b is greater than that of the first reflecting part 130a. Furthermore, the width w of the second reflecting part 130b is greater than that of the first reflecting part 130a. Therefore, some lights emitted from the light source 120 directly hit the second reflecting part 130b without being reflected by the first reflecting part 130a. Accordingly, the lights refracted out of the lighting device 100 are consistent after the lights are reflected by the first or the second reflecting part.

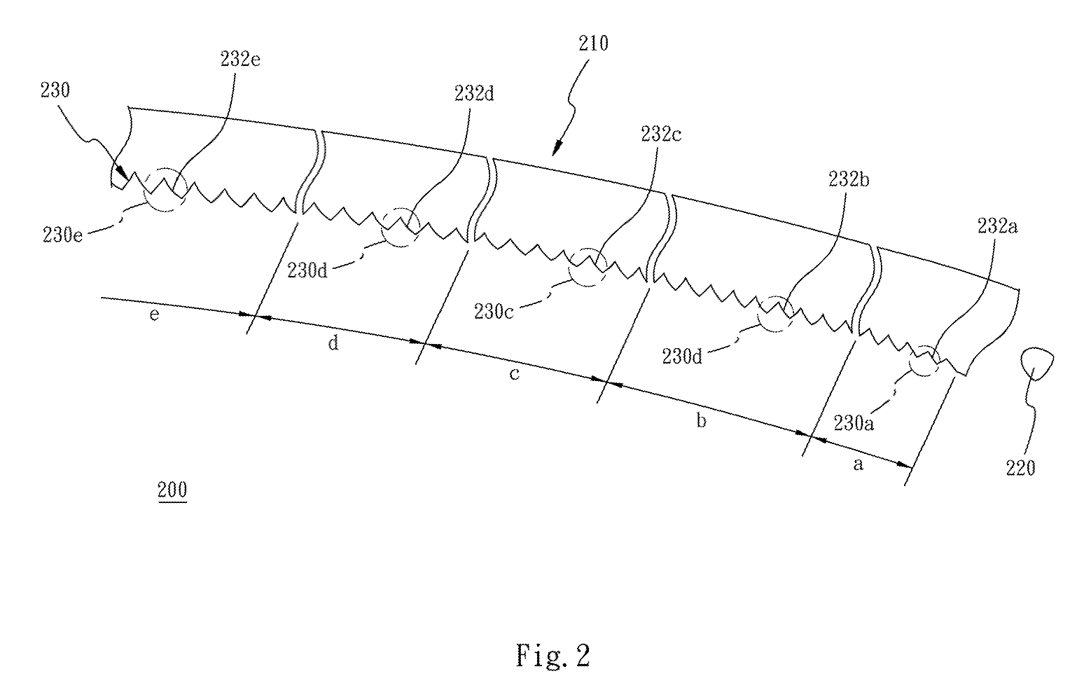

FIG. 2 is a plane view of a lighting device 200 for a vehicle according to another embodiment of this invention. The detail structures of the light conducting rod 210 and the light source 220 are substantially the same as those of the lighting device 100 of the foregoing embodiment. The difference between the lighting devices 100 and 200 is as follows.

According to the embodiment, the reflecting parts 230 are divided into several segments. Each segment has more than two reflecting parts 230. In detail, the reflecting parts 230 are divided into five segments, the first segment a to the fifth segment e. The first segment a has several first reflecting parts 230a, the second segment b has several second reflecting parts 230b, and so on, as shown as FIG. 2. A first distance between the first segment a and the light source 220 is less than a second distance between the second segment b and the light source 220, the second distance is less than a third distance between the third segment c and the light source 220, and so on.

Each first reflecting part 230a has a linear side 232a toward the light source 220, and each of the other reflecting parts 230b, 230c, 230d, 230e has a curved side 232b, 232c, 232d, 232e toward the light source 220. The curvatures of the curved sides 232b of the second reflecting parts 230b are the same, the curvatures of the curved sides 232c of the third reflecting parts 230c are the same, and so on. In addition, the curvatures of the curved sides 232c of the third reflecting parts 230c are greater than that of the curved sides 232b of the second reflecting parts 230b, the curvatures of the curved sides 232d of the forth reflecting parts 230d are greater than that of the curved sides 232c of the third reflecting parts 230c, and so on. In other words, the curvatures of the curved sides 232b of the second reflecting parts 230b are smallest, and the curvatures of the curved sides 232e of the fifth reflecting parts 230e are largest. According to an embodiment, the curved sides of the reflecting parts are high-order surfaces. The high-order surface means a surface with third-order or more than third-order.

In addition, the depths of the reflecting parts 230 are positively correlated with the distances between the reflecting parts 230 and the light source 220. For example, the depth of the first reflecting part 230a can be increased as the increase of a first distance between the first reflecting part 230a and the light source 220. Furthermore, the depths of the first reflecting parts 230a are smaller than that of the second reflecting parts 230b, the depths of the second reflecting parts 230b are smaller than that of the third reflecting parts 230c, and so on. In other words, the more distance between the reflecting part with the light source is, the more depth of the reflecting part is.

The relationship between the widths of the reflecting parts 230 is similar to the foregoing embodiment. The details are not described again.

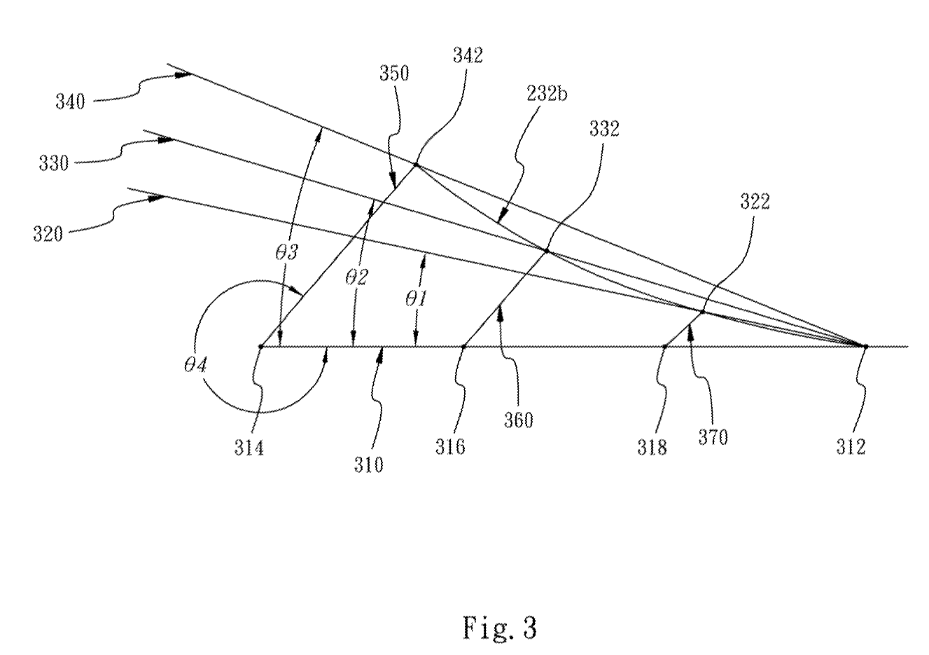

FIG. 3 is a plane view of the curved side 232e of the reflecting part 230e of FIG. 2. The method for designing the curved sides of the reflecting parts is described as following. It is appreciated that the designing method described hereinafter is only one embodiment of the present invention and is not intended to limit the scope of the invention.

In FIG. 3, a non-specific reflecting part 230e is taken as an example to illustrate how to design the reflecting parts 230b-230e. Angles θ1-θ4 are determined according to the incident angles of lights intended to hit the curved side 232e. A horizontal line 310 is created from the origin corner 312. Reference lines 320-340 are created from the origin corner 312, wherein the reference lines 320-340 are at the angles θ1-θ3 respectively with the horizontal line 310. The location of an edge corner 314 is determined on the horizontal line 310, wherein the edge corner 314 is separated from the origin corner 312 by a predetermined distance. A linear side 350 is created from the edge corner 314, wherein the linear side 350 is at the angle θ4 with the horizontal line 310. The linear side 350 and the reference line 340 cross at a top corner 342. The horizontal line segment between the edge corner 314 and the origin corner 312 is trisected by points 316 and 318. Reference lines 360 and 370 are created from the points 316 and 318 respectively, wherein the reference lines 360 and 370 are parallel with the linear side 350. The reference line 360 crosses the reference line 330 at a point 332, and the to reference line 370 crosses the reference line 320 at a point 322. The curve side 232e is created from the top corner 342 to the origin corner 312 through the points 332 and 322. The curved side 232e designed by the foregoing method is a third-order surface.

Particularly, the angles θ1, θ2, θ3 are the differences between the incident angles of the lights intended to hit the curved side 232e and the critical angle of the material of the light conducting rod 210. In the present embodiment, assuming that the incident angles of the lights intended to hit the curved side 232e are 60°, 70°, and 80° respectively, and the material of the light conducting rod 210 is polymethylmethacrylate (having a critical angle of 42.15°), the angle θ1 is 17.85° (the differences between 60° and 42.15°), the angle θ2 is 27.85° (the differences between 70° and 42.15°), and the angle θ3 is 37.85° (the differences between 80° and 42.15°).

Furthermore, the angle θ4 is smaller than or equal to the difference between 360° and the critical angle of the material of the light conducting rod 210. In the present embodiment, assuming the material of the light conducting rod 210 is polymethylmethacrylate (having a critical angle of 42.15°), the angle θ4 is 317.85° (the differences between 360° and 42.15°).

The other reflecting parts 230b, 230c, 230d can be designed by the foregoing method, but the incident angles of the lights intended to hit the curved sides of the reflecting parts may vary. In the present embodiment, the incident angles of the lights intended to hit the curved sides 232b are 30°, 40°, and 50° respectively, the incident angles of the lights intended to hit the curved sides 232c are 40°, 50°, and 60° respectively, and the incident angles of the lights intended to hit the curved sides 232d are 50°, 60°, and 70° respectively.

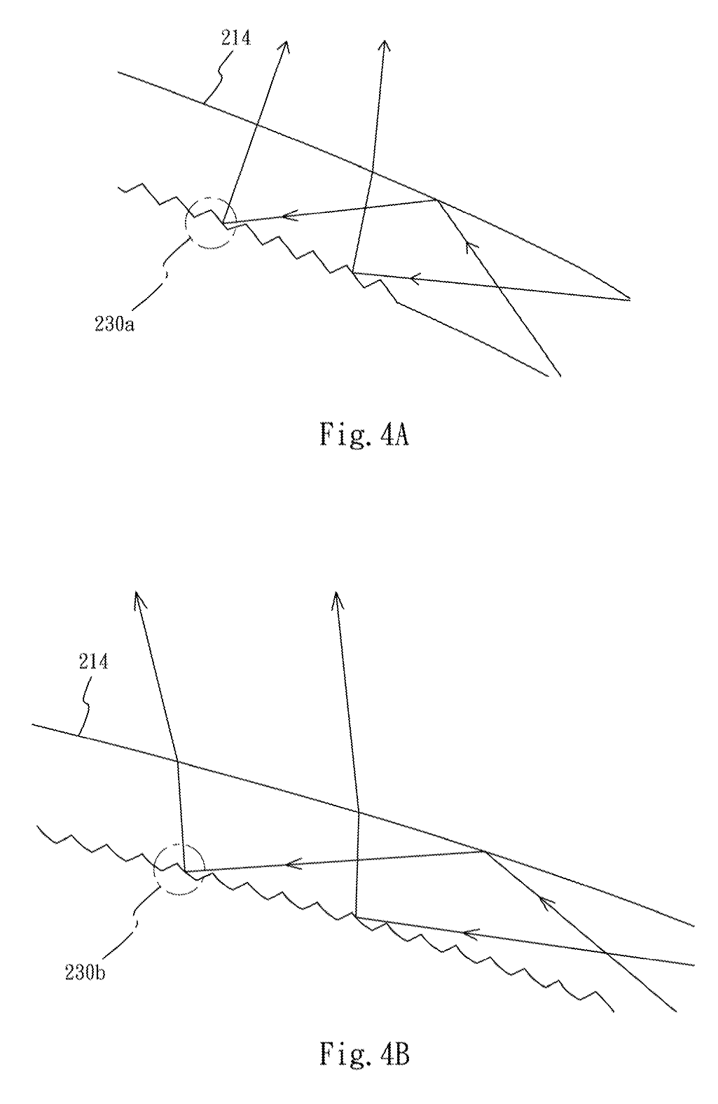

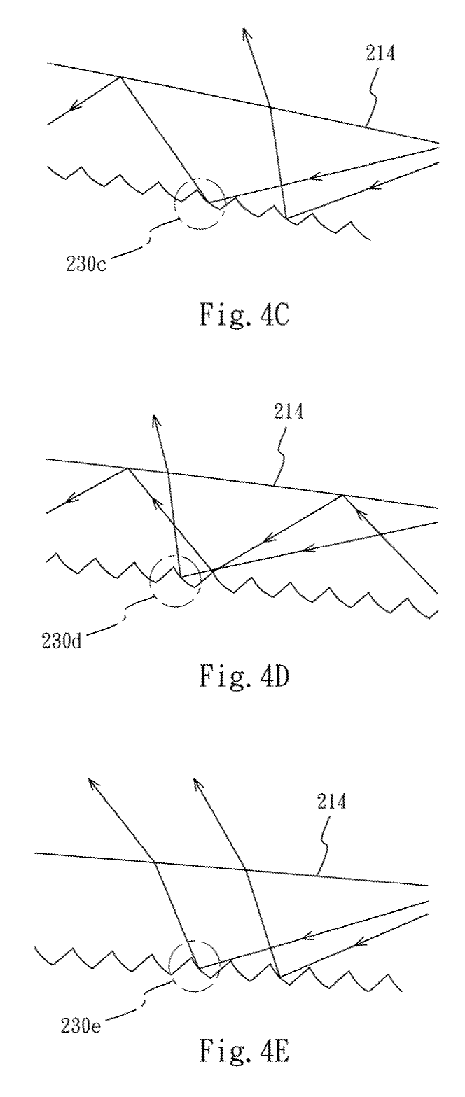

FIGS. 4A-4E are plane views of the lights hitting the reflecting parts 230a-230e sequentially. The lights are represented by arrow lines in FIGS. 4A-4E. The total reflections of the incident lights are destroyed by the different curvatures of the reflecting parts and the high-order surfaces of the curved sides when the incident lights are reflected by the curved sides of the reflecting parts. Therefore, some lights, which are reflected by every reflecting part, are refracted out of the lighting device from the light-emitting surface 214. The overall lighting device can emit the lights with consistent brightness.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims is not intended to invoke the provisions of 35 U.S.C. §112, 6th paragraph.

What is claimed is:

1. A lighting device for a vehicle, the lighting device comprising:
a light conducting rod;
at least one light source connected to at least one end of the light conducting rod;
at least one first reflecting part located on the light conducting rod and having a reflecting surface toward the light source; and
at least one second reflecting part located on the light conducting rod and having a reflecting surface toward the light source, wherein a first distance between the first reflecting part and the light source is less than a second distance between the second reflecting part and the light source, and the curvature of the reflecting surface of the second reflecting part is greater than the curvature of the reflecting surface of the first reflecting part.

2. The lighting device of claim 1, wherein the curvatures of the reflecting surfaces of a plurality of the first reflecting parts are the same.

3. The lighting device of claim 1, wherein the curvatures of the reflecting surfaces of a plurality of the second reflecting parts are the same.

4. The lighting device of claim 1, further comprising:
at least one third reflecting part located on the light conducting rod and having a reflecting surface toward the light source, wherein a third distance between the third reflecting part and the light source is greater than the second distance, and the curvature of the reflecting surface of the third reflecting part is greater than the curvature of the reflecting surface of the second reflecting part.

5. The lighting device of claim 1, wherein the depth of the second reflecting part is greater than the depth of the first reflecting part.

6. The lighting device of claim 1, wherein the width of the second reflecting part is greater than the width of the first reflecting part.

7. The lighting device of claim 1, wherein the light conducting rod is bar-shaped.

8. A lighting device for a vehicle, the lighting device comprising:
a light conducting rod;
at least one light source connected to at least one end of the light conducting rod;
at least one first protrusion located on the light conducting rod and having a linear side toward the light source;
at least one second protrusion located on the light conducting rod and having a curved side toward the light source, wherein a first distance between the first protrusion and the light source is less than a second distance between the second protrusion and the light source; and
at least one third protrusion located on the light conducting rod and having a curved side toward the light source, wherein the second distance is less than a third distance between the third protrusion and the light source, and the curvature of the curved side of the third protrusion is greater than the curvature of the curved side of the second protrusion.

9. The lighting device of claim 8, wherein the curvatures of the curved sides of a plurality of the second protrusions are the same.

10. The lighting device of claim 8, wherein the curved side of the second protrusion is a high-order surface.

11. The lighting device of claim 8, wherein the curved side of the third protrusion is a high-order surface.

12. The lighting device of claim 8, wherein the curvatures of the curved sides of a plurality of the third protrusions are the same.

13. The lighting device of claim 8, wherein the width of the first protrusion is smaller than that of the second protrusion.

14. The lighting device of claim 8, wherein the width of the second protrusion is smaller than that of the third protrusion.

15. The lighting device of claim 8, wherein the depth of the first protrusion is smaller than that of the second protrusion.

16. The lighting device of claim 8, wherein the depth of the second protrusion is smaller than that of the third protrusion.

17. The lighting device of claim 8, wherein the depths of a plurality of the first protrusions are positively correlated with the first distances between the first protrusions and the light source.

18. The lighting device of claim 8, wherein the light conducting rod is bar-shaped.
